(19) United States
(12) Patent Application Publication
(10) Pub. No.: US 2011/0196718 A1
(43) Pub. Date: Aug. 11, 2011

(54) SYSTEM AND METHOD FOR FORECASTING IN THE PRESENCE OF MULTIPLE SEASONAL PATTERNS IN PRINT DEMAND

(75) Inventors: Rakesh Suresh Kulkarni, Webster, NY (US); Sudhendu Rai, Fairport, NY (US)

(73) Assignee: XEROX CORPORATION, Norwalk, CT (US)

(21) Appl. No.: 12/702,556

(22) Filed: Feb. 9, 2010

(51) Int. Cl. G06Q 10/00; G06Q 50/00

(52) U.S. Cl. 705/7.31; 705/28

(57) ABSTRACT

A system for forecasting an inventory level for a consumable in a print production environment may include a computing device and a computer-readable storage medium in communication with the computing device. The computer-readable storage medium may include one or more programming instructions for identifying a demand distribution for a print product resource consumable, identifying a first seasonal period in the demand distribution, creating a seasonally adjusted demand distribution, identifying a second seasonal period in the seasonally adjusted demand distribution, creating an updated seasonally adjusted demand distribution, using a forecasting model to automatically forecast a predicted future demand value for the consumable, updating the predicted future demand value using, determining whether additional inventory is needed based on at least the updated predicted future demand value, and in response to a need for additional inventory, generating an order for the print product resource consumable.

### BACKGROUND

Forecasting print demand is an important consideration in managing inventory and planning capacity of a print shop. Typically, forecasting print demand is accomplished using standard statistical algorithms, such as the Autoregressive Integrated Moving Average (ARIMA) algorithm, which are only capable of handling one seasonal period. In the printing industry, however, print demand often includes multiple seasonal patterns. As such, it is often difficult to accurately forecast print demand in the presence of multiple seasonal patterns.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In an embodiment, a system for forecasting an inventory level for a consumable in a print production environment may include a computing device and a computer-readable storage medium in communication with the computing device. The computer-readable storage medium may include one or more programming instructions for identifying a demand distribution for a print product resource consumable in a print production environment, identifying a first seasonal period in the demand distribution, creating a seasonally adjusted demand distribution by removing a first seasonal component associated with the first seasonal period the demand distribution, identifying a second seasonal period in the seasonally adjusted demand distribution, and creating an updated seasonally adjusted demand distribution by removing a second seasonal component associated with the second seasonal period from the seasonally adjusted demand distribution. The computer-readable storage medium may also include programming instructions for using a forecasting model to automatically forecast a predicted future demand value for the consumable based on the updated seasonally adjusted demand distribution, updating the predicted future demand value using one or more of the first seasonal component and the second seasonal component, determining whether additional inventory is needed based on at least the updated predicted future demand value, and in response to a need for additional inventory, generating an order for the print product resource consumable.

In an embodiment, a system for forecasting an inventory level for a consumable in a print production environment may include a computing device and a computer-readable storage medium in communication with the computing device. The computer-readable storage medium may include one or more programming instructions for identifying a demand distribution for a print product resource consumable in a print production environment, where the demand distribution may include a plurality of seasonal periods, applying an Autocorrelation Function (ACF) to the demand distribution to identify a first seasonal period, creating a seasonally adjusted demand distribution by removing a first seasonal component associated with the first seasonal period from the demand distribution, and applying the ACF to the seasonally adjusted demand distribution to identify a second seasonal period. The computer-readable storage medium may include one or more programming instructions for creating an updated seasonally adjusted demand distribution by removing a second seasonal component associated with the identified second seasonal period from the seasonally adjusted demand distribution, using an ARIMA model to automatically forecast a predicted future demand value for the print product resource consumable based on the updated seasonally adjusted demand distribution, updating the predicted future demand value using one or more of the first seasonal component and the second seasonal component, determining whether additional inventory is needed based on at least the updated predicted future demand value, and in response to a need for additional inventory, generating an order for the print product resource consumable.

In an embodiment, a system for forecasting an inventory level for a consumable in a print production environment may include a computing device and a computer-readable storage medium in communication with the computing device. The computer-readable storage medium may include one or more programming instructions for identifying, by a computing device, a demand distribution for a print product resource consumable in a print production environment, where the print product resource consumable may be configured to be used by a print production resource, identifying a first seasonal period in the demand distribution, creating a seasonally adjusted demand distribution by removing a first seasonal component associated with the first seasonal period from the demand distribution, and identifying a second seasonal period in the seasonally adjusted demand distribution. The computer-readable storage medium may include one or more programming instructions for creating an updated seasonally adjusted demand distribution for the second seasonal period by removing a second seasonal component associated with the second seasonal period from the seasonally adjusted demand distribution, repeating, for each second seasonal period having an autocorrelation function value that exceeds a threshold value at a time-lag, the identifying a second seasonal period and creating an updated seasonally adjusted demand distribution, using a forecasting model to automatically forecast a predicted future demand value for the print product resource consumable, updating the predicted future demand value using one or more of the first seasonal component and one or more of the second seasonal components, determining whether additional inventory is needed based on at least the updated predicted future demand value, and in response to a need for additional inventory, generating an order for the print product resource consumable.

### BRIEF DESCRIPTION OF THE DRAWINGS

Aspects, features, benefits and advantages of the present invention will be apparent with regard to the following description and accompanying drawings, of which:

FIG. 1 illustrates an exemplary method of forecasting inventory according to an embodiment.

FIG. 2 illustrates an exemplary demand distribution according to an embodiment.

FIG. 3 illustrates an exemplary ACF plot according to an embodiment.

FIG. 4 illustrates an exemplary graph showing a seasonal component according to an embodiment.

FIG. 5 illustrates an exemplary graph showing a seasonal component according to an embodiment.

FIG. 6 illustrates an exemplary graph showing a demand distribution, seasonal components and an adjusted future demand associated with the demand distribution and the seasonal components according to an embodiment.

FIG. 7 illustrates a block diagram of exemplary internal hardware that may be used to contain or implement program instructions according to an embodiment.

### DETAILED DESCRIPTION

For purposes of the discussion below, a “job” refers to a logical unit of work that is to be completed for a customer. A job may include one or more print jobs from one or more clients.

A “print job” refers to a job processed in a print production system. For example, a print job may include producing credit card statements corresponding to a certain credit card company, producing bank statements corresponding to a certain bank, printing a document, or the like. Although the disclosed embodiments pertain to print jobs, the disclosed methods and systems can be applied to jobs in general in other production environments, such as automotive manufacturing, semiconductor production and the like.

A “resource” is a device that performs a processing function on a job. For example, in a print production environment, a resource may include a printer, a copier, a binder, a hole-punch, a collator, a sealer or any other equipment used to process print jobs.

A “print shop” refers to an entity that includes a plurality of document production resources, such as printers, cutters, collators and the like. A print shop may be a freestanding entity, including one or more print-related devices, or it may be part of a corporation or other entity. Additionally, a print shop may communicate with one or more servers by way of a local area network or a wide area network, such as the Internet, the World Wide Web or the like.

An “enterprise” is a production environment that includes multiple items of equipment to manufacture and/or process jobs that may be customized based on customer requirements. For example, in a print production environment, an enterprise may include a plurality of print shops.

A “seasonal period” is any reasonably identifiable subset of a substantially cyclical time period. For example, a seasonal period may be one or more months within a calendar year, one or more days within a week, one or more hours within a day and/or any other subset of a time period.

A “seasonal component” is a variation in a demand distribution that recurs at certain time intervals. For example, a seasonal component may be a variation in a demand distribution that recurs every seasonal period.

An “inventory position” is the inventory at a storage location, such as a warehouse, plus any inventory that has been ordered but not yet delivered minus inventory that is backordered.

“Job demand information” is the job volume associated with a production environment over a certain time period. For example, in a print production environment, job demand information may include print job volume associated with a print shop over a certain time period.

A “consumable” is an item that is utilized by a production environment in the processing of jobs. An inventory of a consumable may be depleted by the use of the consumable. In a print production environment, a consumable may include ink, paper, toner, wire for staples, envelopes, binding materials and/or the like.

A “demand distribution” is a distribution of demand associated with a consumable over a period of time.

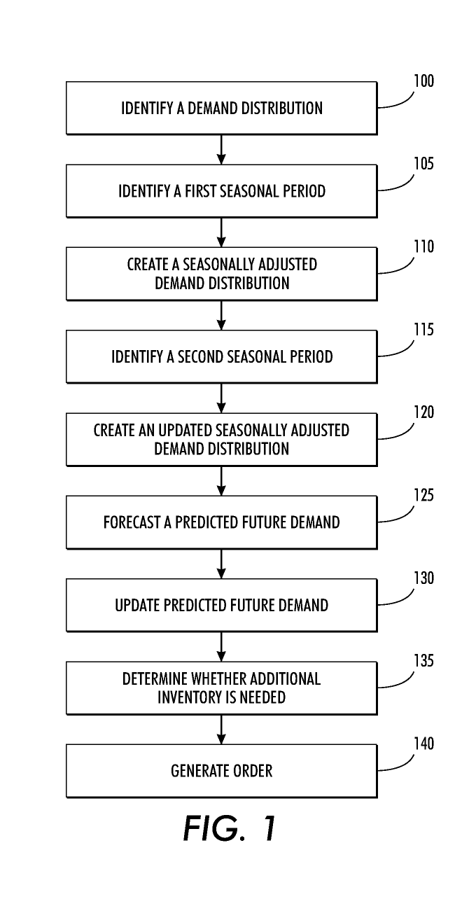

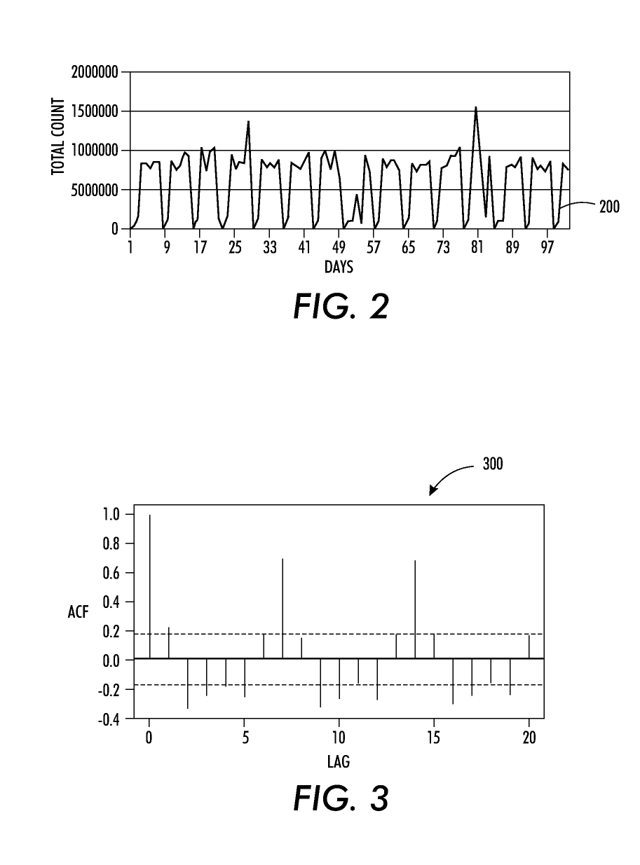

FIG. 1 illustrates an exemplary method of forecasting inventory levels in a print production environment according to an embodiment. A demand distribution for a consumable in a production environment may be identified 100. In an embodiment, a demand distribution for a consumable may be identified 100 by collecting job demand information from one or more resources in a print production environment. In an embodiment, a demand distribution for a consumable may be determined by aggregating the demand for a consumable over a period of time. The demand distribution may be represented by a time series d(i), where i denotes the i^{th} point in the time series. FIG. 2 illustrates an exemplary demand distribution 200 according to an embodiment. As illustrated, the demand 200 associated with the consumable may be variable.

In an embodiment, a demand distribution for a consumable may include one or more seasonal periods. Referring back to FIG. 1, a seasonal period may be identified 105 from the demand distribution. In an embodiment, an Autocorrelation Function (“ACF”) may be used to identify 105 a seasonal period. An ACF of a demand distribution may describe the correlation between values of the distribution that are separated by time-lags. In an embodiment, an ACF of a demand distribution associated with a consumable may be observed to determine whether a value of the ACF at a specified time-lag is greater than a threshold value. If so, the demand distribution may exhibit a seasonal period.

Demands d(i) and d(i−k) may be separated by a time-lag of k time units. When demand has a seasonal period at time-lag k and a mean of d̅, demands d(i) and d(i−k) may be highly correlated for i=k+1, k+2, k+3, . . . n. Whether demand has a seasonal period may be determined by testing whether an ACF value exceeds a threshold value for some value of k. An ACF may be defined as:

$$acf ( k ) = \frac{{\sum }_{i = k + 1}^{n} ( ( d ( i ) - \overline{d} ) ( d ( i - k ) - \overline{d} ) )}{{\sum }_{i = 1}^{n} {( d ( i ) - d )}^{2}}$$

FIG. 3 illustrates an exemplary ACF plot 300 corresponding to the demand distribution illustrated in FIG. 2. In an embodiment, an ACF value at a time-lag that most exceeds a threshold value may be identified as a most dominant seasonal period. In an embodiment, a threshold value may be determined based on ACF values of white noise data having a sampling distribution that may be approximated by a normal curve having a certain mean and standard error. For example, a threshold value may be represented by

$$\frac{1.96}{{n}^{2}} ,$$

where n is the number of demand data points in the demand distribution, and the threshold value is approximated by a normal curve with a zero mean and a standard error of

$$\frac{1}{{n}^{0.5}} .$$

Additional and/or alternate threshold values, mean values and/or standard error values may be used within the scope of this disclosure.

In an embodiment, using a threshold value of

$$\frac{1.96}{{n}^{2}} ,$$

the most dominant seasonal period illustrated by FIG. 3 is 7 days (f1=7). As such, the most dominant seasonal period illustrated in FIG. 2 may be 7 days, or weekly.

In an embodiment, a seasonal component associated with the identified seasonal period may be removed from the demand distribution to create 110 a seasonally adjusted demand distribution. In an embodiment, a seasonal component associated with the identified seasonal period may be separated from the demand distribution using STL decomposition. STL decomposition is a technique that may be used to, separate data into seasonal, trend and remainder components. Additional information regarding STL decomposition can be found in Cleveland, R. B., Cleveland, W. S., McRae, J. E., Terpenning, I.: STL: A Seasonal-Trend Decomposition Procedure Based on Loess, J. Official Statistics, 3-73, 1990.

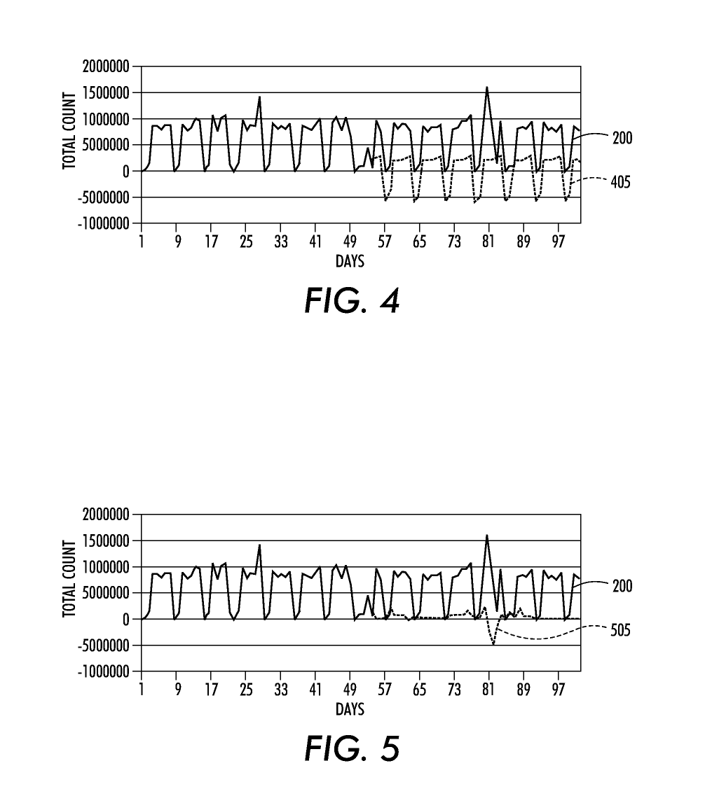

In an embodiment, a trend component may represent a low frequency variation in the demand distribution and nonstationary, long-term changes in level. In an embodiment, a seasonal component may represent variation in the demand distribution at or near the seasonal frequency. For example, FIG. 4 illustrates an exemplary graph showing a seasonal component 405 of the demand distribution 200 illustrated in FIG. 2.

In an embodiment, a remainder component may represent the remaining variation in the demand distribution beyond that in the seasonal and trend components. In an embodiment, a demand distribution having data Yᵥ for v=1 to N may be represented as:

Yᵥ=Tᵥ+Sᵥ+Rᵥ
where:
   Tᵥ is the trend component;
   Sᵥ is the seasonal component; and
   Rᵥ is the remainder component

In an embodiment, STL decomposition may involve two recursive procedures. For example, STL decomposition may involve an inner loop nested inside an outer loop. In each of nᵢ passes through the inner loop, the seasonal component and the trend component may be updated. In an embodiment, each pass of the outer loop may involve a pass through the inner loop followed by a computation of one or more robustness weights. The robustness weights may be used in the next iteration of the inner loop to reduce the influence of atypical behavior on the trend and seasonal components. In an embodiment, an initial iteration of the outer loop may be performed using robustness weights equal to ‘1.’

In an embodiment, a second seasonal period may be identified 115 in the seasonally adjusted demand distribution. In an embodiment, the second seasonal period may be identified 115 using an ACF as described above. For example, a second seasonal period of 30 days may be identified 115 from FIG. 2. In an embodiment, an updated seasonally adjusted demand distribution may be created 120 by removing a seasonal component associated with the identified second seasonal period from the adjusted demand distribution as described above. FIG. 5 illustrates an exemplary graph showing the seasonal component 505 of 30 days from the demand distribution 200 illustrated by FIG. 2. In an embodiment, seasonal components may be removed from the seasonally adjusted demand distribution until no seasonal components remain in the distribution with respect to the threshold value. In an embodiment, seasonal components may be removed in an order corresponding to a difference between the corresponding seasonal period's ACF values at a specific time-lag and the threshold value. For example, a seasonal component associated with a seasonal period having a greatest difference between its ACF value and the threshold value at a specific time-lag may be removed first, followed by a seasonal component associated with a seasonal period having a second greatest difference between its ACF value and the threshold value at the same time-lag and so on.

In an embodiment, a forecasting model may be used to forecast 125 a predicted future demand associated with a consumable over a certain period of time. For example, an Autoregressive Integrated Moving Average (“ARIMA”) model, a Seasonal Autoregressive Integrated Moving Average (“SARIMA”) model and/or the like may be fit to the seasonally adjusted demand distribution to forecast a predicted future demand.

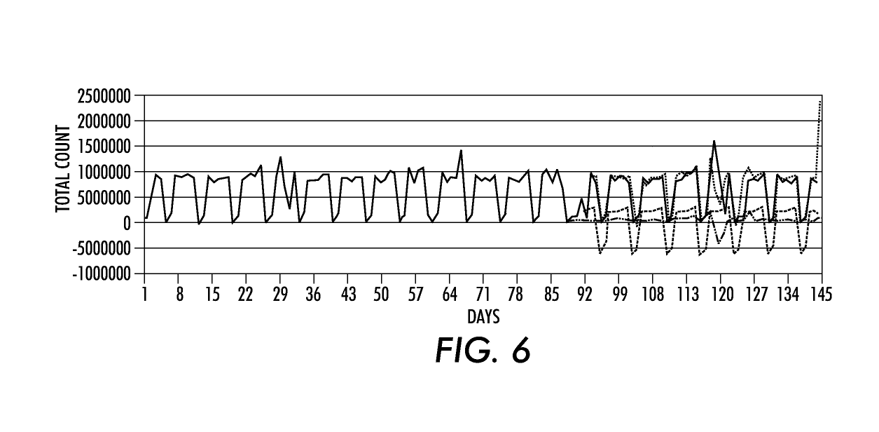

In an embodiment, the predicted future demand may be updated 130 using one or more of the removed seasonal components. For example, the predicted future demand may be updated 130 by adding one or more of the removed seasonal components to the predicted future demand. For example, FIG. 6 illustrates an exemplary graph showing the demand distribution illustrated in FIG. 2, the seasonal components illustrated in FIGS. 4 and 5 and the adjusted future demand associated with the demand distribution and the seasonal components.

In an embodiment, the predicted future demand may be used to determine 135 whether additional inventory of a consumable is needed. The predicted future demand may be compared to an inventory position associated with the consumable. An inventory position is the inventory currently held at a storage location, such as a warehouse, plus any inventory that has been ordered but not yet delivered minus inventory that is backordered. For example, a print production environment may have 50 color ink cartridges in stock and 20 color ink cartridges may have been ordered but not yet delivered. In addition, 15 color ink cartridges may be backordered. As such, the inventory position associated with color ink cartridges is 55 cartridges (i.e., 50+20−15).

If additional inventory is needed, an order for the consumable may be generated 140. In an embodiment, if the predicted future demand equals or exceeds the inventory position, an order for the consumable may be generated 140. The order may be for an amount of the consumable equal to the difference between the predicted future demand and the inventory position. For example, if the predicted future demand associated with white paper is 70 boxes and the inventory position is 50 boxes, then an order may be generated 140 for 20 boxes so the production environment can meet the forecasted demand. In an embodiment, if the predicted future demand exceeds the inventory position, an order for an amount of the consumable greater than the difference between the predicted future demand and the inventory position may be generated 140.

In an embodiment, if the predicted future demand is equal to or less than the inventory position, an order for the consumable may be generated 140. The order may be for a predetermined amount of the consumable. For example, if the predicted future demand equals the inventory position, an order for five units of the consumable may be generated 135 to ensure that the production environment can meet its orders should the actual demand exceed the predicted future demand.

In an embodiment, an order may be generated 140 if the predicted future demand exceeds the inventory position value by a predetermined amount. For example, an order may be generated 140 if the predicted future demand exceeds the inventory position value by five or fewer units. In an embodiment, the order may be for a predetermined amount of the consumable. For example, if the predicted future demand exceeds the inventory position value by five or fewer units, an order for five units of the consumable may be placed 140. Alternatively, if the inventory position value equals or exceeds the predicted future demand, an order for the consumable may not be placed.

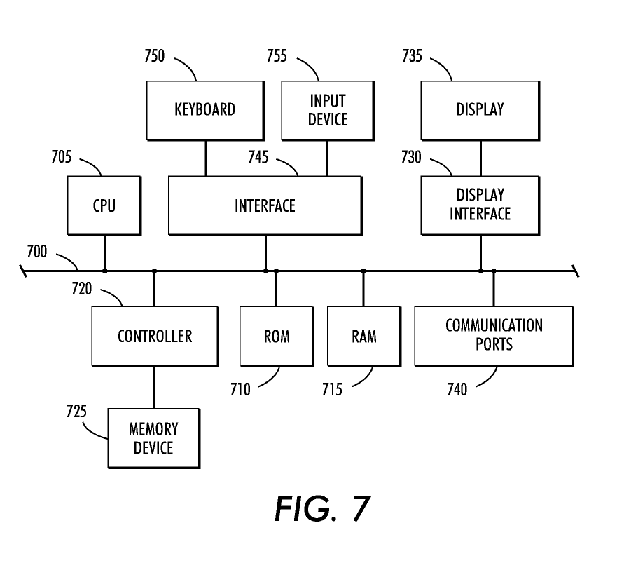

FIG. 7 depicts a block diagram of exemplary internal hardware that may be used to contain or implement program instructions according to an embodiment. A bus 700 serves as the main information highway interconnecting the other illustrated components of the hardware. CPU 705 is the central processing unit of the system, performing calculations and logic operations required to execute a program. Read only memory (ROM) 710 and random access memory (RAM) 715 constitute exemplary memory devices.

A controller 720 interfaces with one or more optional memory devices 725 to the system bus 700. These memory devices 725 may include, for example, an external or internal DVD drive, a CD ROM drive, a hard drive, flash memory, a USB drive or the like. As indicated previously, these various drives and controllers are optional devices.

Program instructions may be stored in the ROM 710 and/or the RAM 715. Optionally, program instructions may be stored on a tangible computer readable storage medium such as a compact disk, a digital disk, flash memory, a memory card, a USB drive, an optical disc storage medium, such as Blu-ray™ disc, and/or other recording medium.

An optional display interface 730 may permit information from the bus 700 to be displayed on the display 735 in audio, visual, graphic or alphanumeric format. Communication with external devices may occur using various communication ports 740. An exemplary communication port 740 may be attached to a communications network, such as the Internet or an intranet.

The hardware may also include an interface 745 which allows for receipt of data from input devices such as a keyboard 750 or other input device 755 such as a mouse, a joystick, a touch screen, a remote control, a pointing device, a video input device and/or an audio input device.

An embedded system, such as a sub-system within a xerographic apparatus, may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for forecasting an inventory level for a consumable in a print production environment, the system comprising:
a computing device;
a computer-readable storage medium in communication with the computing device, wherein the computer-readable storage medium comprises one or more programming instructions for:
identifying a demand distribution for a print product resource consumable in a print production environment,
identifying a first seasonal period in the demand distribution,
creating a seasonally adjusted demand distribution by removing a first seasonal component associated with the first seasonal period the demand distribution,
identifying a second seasonal period in the seasonally adjusted demand distribution,
creating an updated seasonally adjusted demand distribution by removing a second seasonal component associated with the second seasonal period from the seasonally adjusted demand distribution,
using a forecasting model to automatically forecast a predicted future demand value for the consumable based on the updated seasonally adjusted demand distribution,
updating the predicted future demand value using one or more of the first seasonal component and the second seasonal component,
determining whether additional inventory is needed based on at least the updated predicted future demand value, and
in response to a need for additional inventory, generating an order for the print product resource consumable.

2. The system of claim 1, wherein the one or more programming instructions for identifying a first seasonal period comprise one or more programming instructions for:
applying an Auto Correlation Function (ACF) to the demand distribution to identify one or more time-lags in the demand distribution;
for each identified time-lag, determining a difference value by determining a difference between an autocorrelation value associated with identified time-lag and a threshold value; and
identifying as the first seasonal period the time-lag associated with a greatest difference value.

3. The system of claim 1, wherein the one or more programming instructions for creating a seasonally adjusted demand distribution comprise one or more programming instructions for using STL decomposition to separate the first seasonal component from the demand distribution.

4. The system of claim 1, wherein the one or more programming instructions for identifying a second seasonal period comprise one or more programming instructions for:
applying an Autocorrelation Function (ACF) to the seasonally adjusted demand distribution to identify one or more time-lags;
for each identified time-lag, determining an associated difference value by determining a difference between an autocorrelation value associated with the time-lag and a threshold value; and
identifying as the second seasonal period the time-lag associated with a greatest difference value.

5. The system of claim 1, wherein the one or more programming instructions for creating an updated seasonally adjusted demand distribution comprise one or more programming instructions for using STL decomposition to separate the second seasonal component from the seasonally adjusted demand distribution.

6. The system of claim 1, wherein the one or more programming instructions for using a forecasting model comprise one or more programming instructions for using one or more of the following:
an ARIMA model; and
a SARIMA model.

7. The system of claim 1, wherein the one or more programming instructions for determining whether additional inventory is needed comprise one or more programming instructions for determining whether the updated predicted future demand value exceeds an inventory position associated with the print product resource consumable.

8. The system of claim 1, wherein the one or more programming instructions for generating an order for the print product resource consumable comprise one or more programming instructions for generating an order for an amount of the print product resource consumable equal to at least a difference between an inventory position associated with the print product resource consumable and the updated predicted future demand value.

9. A system for forecasting an inventory level for a consumable in a print production environment, the system comprising:
a computing device;
a computer-readable storage medium in communication with the computing device, wherein the computer-readable storage medium comprises one or more programming instructions for:
identifying a demand distribution for a print product resource consumable in a print production environment, wherein the demand distribution comprises a plurality of seasonal periods,
applying an Autocorrelation Function (ACF) to the demand distribution to identify a first seasonal period,
creating a seasonally adjusted demand distribution by removing a first seasonal component associated with the first seasonal period from the demand distribution,
applying the ACF to the seasonally adjusted demand distribution to identify a second seasonal period,
creating an updated seasonally adjusted demand distribution by removing a second seasonal component associated with the identified second seasonal period from the seasonally adjusted demand distribution,
using an ARIMA model to automatically forecast a predicted future demand value for the print product resource consumable based on the updated seasonally adjusted demand distribution,
updating the predicted future demand value using one or more of the first seasonal component and the second seasonal component,
determining whether additional inventory is needed based on at least the updated predicted future demand value, and
in response to a need for additional inventory, generating an order for the print product resource consumable.

10. The system of claim 9, wherein the one or more programming instructions for identifying a first seasonal period in the demand distribution comprise one or more programming instructions for:
applying the ACF to the demand distribution to identify one or more time-lags;
for each identified time-lag, determining an associated difference value by determining a difference between an autocorrelation value associated with the time-lag and a threshold value; and
identifying as the first seasonal period the time-lag having a greatest difference value.

11. The system of claim 9, wherein the one or more programming instructions for creating an updated seasonally adjusted demand distribution comprise one or more programming instructions for using STL decomposition to separate the first seasonal component from the demand distribution.

12. The system of claim 9, wherein the one or more programming instructions for determining whether additional inventory is needed comprise one or more programming instructions for determining whether the updated predicted future demand value exceeds an inventory position associated with the print product resource consumable.

13. The system of claim 9, wherein the one or more programming instructions for generating an order for the print product resource consumable comprise one or more programming instructions for generating an order for an amount of the print product resource consumable equal to a difference between an inventory position associated with the print product resource consumable and the updated predicted future demand value.

14. A system for forecasting an inventory level for a consumable in a print production environment, the system comprising:
a computing device;
a computer-readable storage medium in communication with the computing device, wherein the computer-readable storage medium comprises one or more programming instructions for:
identifying, by a computing device, a demand distribution for a print product resource consumable in a print production environment, wherein the print product resource consumable is configured to be used by a print production resource,
identifying a first seasonal period in the demand distribution,
creating a seasonally adjusted demand distribution by removing a first seasonal component associated with the first seasonal period from the demand distribution,
identifying a second seasonal period in the seasonally adjusted demand distribution,
creating an updated seasonally adjusted demand distribution for the second seasonal period by removing a second seasonal component associated with the second seasonal period from the seasonally adjusted demand distribution,
repeating, for each second seasonal period having an autocorrelation function value that exceeds a threshold value at a time-lag, the identifying a second seasonal period and creating an updated seasonally adjusted demand distribution,
using a forecasting model to automatically forecast a predicted future demand value for the print product resource consumable,
updating the predicted future demand value using one or more of the first seasonal component and one or more of the second seasonal components,
determining whether additional inventory is needed based on at least the updated predicted future demand value, and
in response to a need for additional inventory, generating an order for the print product resource consumable.

15. The system of claim 14, wherein the one or more programming instructions for identifying a first seasonal period comprise one or more programming instructions for:
applying an Auto Correlation Function (ACF) to the demand distribution to generate an ACF plot;
identifying one or more time-lags in the ACF plot;
for each identified time-lag, determining an associated difference value by determining a difference between an autocorrelation value associated with the identified time-lag and a threshold value; and
identifying as the first seasonal period the time-lag having a greatest difference value.

16. The system of claim 14, wherein the one or more programming instructions for creating a seasonally adjusted demand distribution comprise one or more programming instructions for using STL decomposition to separate the first seasonal component from the demand distribution.

17. The system of claim 14, wherein the one or more programming instructions for using a forecasting model comprise one or more programming instructions for using one or more of the following:
an ARIMA model; and
a SARIMA model.

18. The system of claim 14, wherein the one or more programming instructions for determining whether additional inventory is needed comprise one or more programming instructions for determining whether the updated predicted future demand value exceeds an inventory position associated with the print product resource consumable.

19. The system of claim 14, wherein the one or more programming instructions for generating an order for the consumable comprise one or more programming instructions for generating an order for an amount of the consumable equal to a difference between the inventory position and the updated predicted future demand value.
